(19) United States
(12) Patent Application Publication
(10) Pub. No.: US 2017/0114978 A1
(43) Pub. Date: Apr. 27, 2017

(54) ASSEMBLY HAVING AN ILLUMINABLE CLEAR DISPLAY SURFACE COUPLED TO A REMOTE LIGHT SOURCE BY A HIDDEN OPTICAL WAVEGUIDE

(71) Applicant: Kumar Singarajan, Rochester Hills, MI (US)

(72) Inventor: Kumar Singarajan, Rochester Hills, MI (US)

(21) Appl. No.: 14/920,950

(22) Filed: Oct. 23, 2015

(51) Int. Cl. F21S 8/10

(52) U.S. Cl. CPC F21S 48/2243

(57) ABSTRACT

An assembly for an automotive vehicle. The assembly has a body having an opaque Class A exterior surface and a light slab having a clear display surface contiguous to the opaque Class A exterior surface. A light source disposed remote from the clear display surface of the light slab is coupled to the light slab by a hidden optical waveguide. The exterior Class A surface of the body and the display surface of the light slab cooperate to provide a uniform Class A surface when the light slab is unlit. In an aspect, the assembly includes an optical sensor responsive to a sensor section of the exterior display surface being blocked and providing an input indicative thereof to the vehicle.

### FIELD

The present invention relates to assemblies for automotive vehicles having an illuminable clear display surface.

### BACKGROUND

Present day automotive vehicles have a center high mounted stop light, referred to as a CHMSI. Many times, the vehicles also have exterior mirrors that have illuminated turn signal indicators that flash when a turn is signaled by a driver—the turn signal indicator(s) on the left side mirror flashing when a left turn is signaled and the turn signal indicator(s) on the right side mirror flashing when a right turn is signaled. These devices typically include a light source and lens that are separate parts of the devices and are readily visible both when lit and when unlit and thus observable as distinct parts. In many cases, the light source is packaged with the lens as part of the device. In some cases, the light source is located remotely from the device and a component such as a light guide used to pipe the light to the lens. In the latter case, the lens is still readily visible when the light source is unlit and thus observable as a distinct part.

### SUMMARY

An assembly for an automotive vehicle. The assembly has a body having an opaque Class A exterior surface and a light slab having a clear display surface contiguous to the opaque Class A exterior surface. A light source disposed remote from the clear display surface of the light slab is coupled to the light slab by a hidden optical waveguide. The exterior Class A surface of the body and the display surface of the light slab cooperate to provide a uniform Class A surface when the light slab is unlit.

In an aspect, the optical waveguide includes an optically engineered lens that flutes light from the light source to the light slab through the optical waveguide.

In an aspect, the light slab is a distal end of the optical waveguide.

In an aspect, the light slab is integral with the body.

In an aspect, the light slab and the body are separate parts.

In an aspect, the external display surface of the light slab is configured as a display of a center high mounted stop light.

In an aspect, the external display surface of a light slab is configured to have a plurality of portion with portions providing rear running lights of the vehicle, portions providing brake lights of the vehicle and a portion providing a center high mounted stop light and the light source is configured to have a plurality of light sources corresponding to the plurality of portions of the external display surface.

In an aspect, the assembly is an exterior mirror for the vehicle where the body is a mirror case of the mirror and the exterior display surface of the light slab is contiguous with at least a portion of a periphery of the mirror case. In an aspect, the exterior display surface extends around the periphery of the mirror case.

In an aspect, the assembly includes a light sensor responsive to a sensor section of the exterior display surface being blocked and providing an input indicative thereof to the vehicle.

### BRIEF DESCRIPTION OF THE DRAWINGS

The present invention will become more fully understood from the detailed description and the accompanying drawings, wherein:

FIG. 1 is a block diagram of an assembly having a body having an Class A exterior surface and a light slab having an exterior display surface that is contiguous with the Class A exterior surface in accordance with an aspect of the present disclosure;

FIG. 2 is a block diagram showing in more detail the light slab of FIG. 1 coupled to a hidden light source by an optical waveguide;

FIG. 3 is a block diagram showing in more detail a light engine having the light source of FIG. 2;

FIG. 4 is a block diagram showing a variation of the assembly of FIG. 1;

FIG. 5 is a perspective view of the assembly of FIG. 1 that is an exterior mirror for a vehicle;

FIG. 6 is a section view taken along the line 6-6 of FIG. 5;

FIG. 7 is a perspective view of the light slab of FIG. 1.

### DETAILED DESCRIPTION

The following description of the preferred embodiment(s) is merely exemplary in nature and is in no way intended to limit the invention, its application, or uses. Corresponding reference numerals indicate corresponding parts throughout the several views of the drawings.

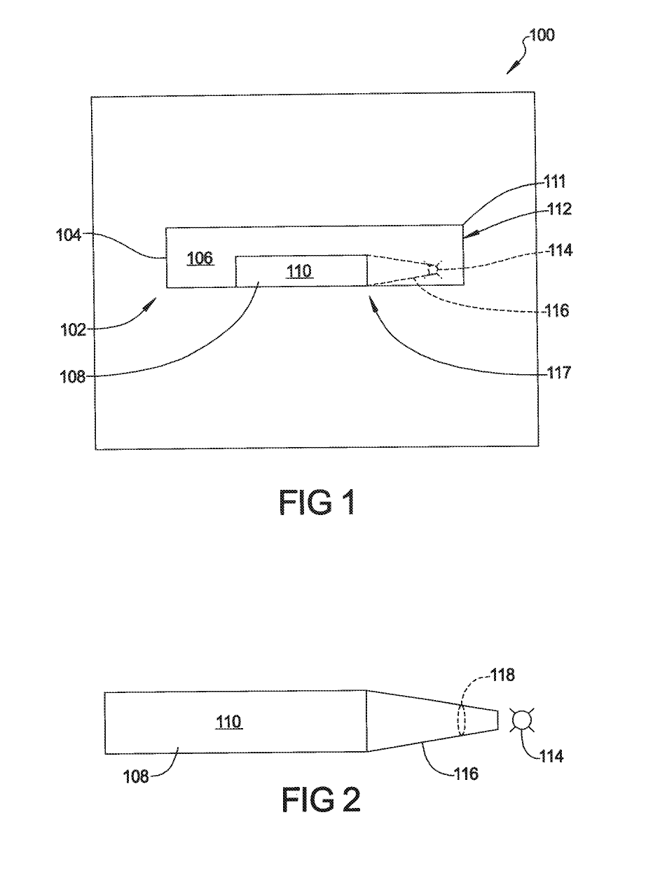

With reference to FIG. 1, in accordance with an aspect of the present disclosure, an automotive vehicle 100 has an assembly 102 that has a body 104 having a Class A exterior surface 106 which in the illustrative embodiment is opaque and a clear light slab 108. As commonly understood in the automotive field and as used herein, Class A surfaces are those surfaces of a vehicle that are readily visible to a user and typically include the surfaces of the components of the interior of the vehicle cabin and the surfaces of the components of the exterior of the vehicle, such as fenders, hoods, trunks, fascia's, grilles, etc. Light slab 108 has a clear exterior display surface 110 that is contiguous with at least a portion of body 104. In an aspect, light slab 108 is formed as part of body 104 when body 104 is formed. In an aspect, body 104 and light slab 108 are separate parts and assembled together, either before assembly 102 is assembled to vehicle 100 or during the assembly of vehicle 100.

Exterior display surface 110 of light slab 108 in cooperation with the Class A exterior surface 106 of the body 104 provides a uniform Class A surface 112 when light slab 108 is unlit, as discussed in more detail below. As used herein, a uniform Class A surface is a Class A surface having a uniform appearance to a casual observer. That is: (i) the surface has the same visual appearance to the casual observer including color and interruptions in the surface are not readily visible to the casual observer; and (ii) when light slab 108 is unlit, exterior display surface 110 is not visibly distinct from and has the same appearance to a casual observer, such as color, as exterior Class A surface 112 due to exterior display surface 110 of light slab 108 being contiguous to body 104. Light slab 108 is coupled to a light source 114 by an optical waveguide 116. An optical waveguide, as known in the art and as used herein, is a physical structure in which a light-transmitting material guides electromagnetic waves in the optical spectrum. Optical waveguides are usually made of optical grade materials such as acrylic resin, polycarbonate, epoxies and glass. In an aspect, optical waveguide 116 includes a lens 118 (shown in phantom in FIG. 2) that flutes the light from light source 114 to light slab 108 through optical waveguide 116. In an aspect, optical waveguide 116 integrally includes light slab 108 as a distal end portion of optical waveguide 116.

Optical waveguide 116 is a hidden optical waveguide which in the context of the present disclosure means that it is masked from view from the exterior of vehicle 100 by opaque Class A exterior surface 106 of body 104. In this regard, optical waveguide 116 is illustratively disposed in body 104 behind opaque Class A exterior surface 106 or behind body 104, in each case when viewed from the exterior of vehicle 100. It should be understood that in this orientation, a front of Class A exterior surface 106 faces exteriorly outwardly so that Class A exterior surface 106 is disposed exterior of optical waveguide 116 from a viewpoint exterior of vehicle 100.

Light source 114 is also a hidden light source. As used herein, hidden light source means that the light source, such as light source 114, is disposed so that it is not in a line of sight from a viewpoint exterior of vehicle 100 by an observer that is at least five feet from the exterior of vehicle 100. In this regard, light source 114 is oriented so that it faces any of surfaces 700, 702, 704, 706 that are orthogonal to display surface 110 but not an interior surface 708 that is opposite and parallel to display surface 110, as best shown in FIG. 7.

Further, surface 708 presents a masking color either by abutting a component of vehicle 100 that has masking color or itself has the masking color, such as by being coated with the masking color. As used herein, a masking color is a color that is the same as the Class A exterior surface or a color that is not easily distinguishable from the color of the Class A exterior surface 106 so that when light source 114 is off and display surface 110 is not illuminated, display surface 110 presents the same appearance to a casual observer from the exterior of vehicle 100 as the Class A exterior surface 106.

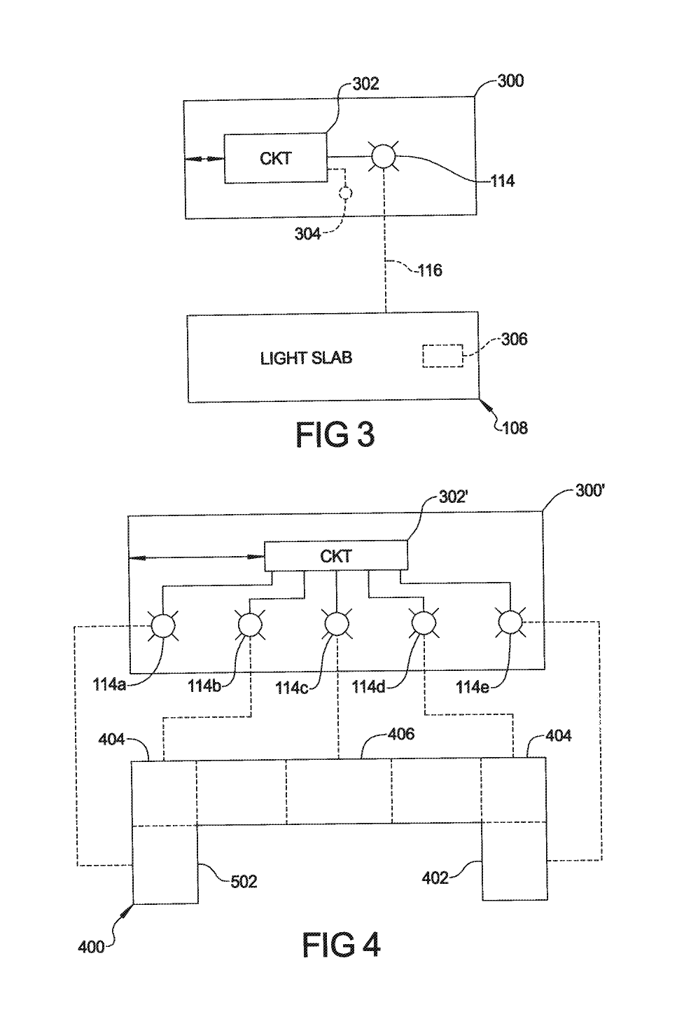

With reference to FIG. 3, a light engine 300 includes light source 114 and a light source drive circuit 302 that drives light source 114. In an example, light source 114 is a light emitting diode and light source drive circuit 302 includes a light emitting diode drive circuit. In an example, light source drive circuit 302 is controlled by an electronic control unit (not shown) of vehicle 100 that for example, controls light source drive circuit 302 to activate light source 114 when brakes of the vehicle 100 are applied. In an example, light source 114 is turned on when the brakes of vehicle 100 are applied and in an example, light source 114 is flashed on and off when the brakes of the vehicle 100 are applied.

Since light slab 108 is clear and is part of assembly 102, when light slab 108 is not lit, the exterior display surface 110 of light slab 108 has the same color to an observer as the color of Class A exterior surface 106 of body 104. Thus, when light slab 108 is unlit, a Class A surface 112 that is Class A exterior surface 106 of body 104 and exterior display surface 110 of light slab 108 has a uniform appearance to an observer. This in effect obscures light slab 108 from appearing as a separate, distinct component from body 104. In contrast, when light source 114 is on, light slab 108 is illuminated by light source 114 and its exterior display surface 110 radiates a visible light to an observer. Further, by removing light source 114 from the surface of the display, exterior display surface 110 of light slab 108 in this case, there is more flexibility in packaging of light source 114 and light slab 108, and in styling and design of light slab 108.

Light source 114 is illustratively located remote from light slab 108, either as part of body 104 or separate from body 104. This allows light engine 300 that includes light source 114 to be located remote from light slab 108 and for example inside vehicle 100 protecting the parts of light engine 300 such as electronics from the outside environment which is often harsher than the environment inside vehicle 100.

It should be understood that light source 114 can include a plurality of light sources 114 separately controlled by light source circuit 302′ of light engine 300′, as shown in the example embodiment of FIG. 4. In the example of FIG. 4, a light slab 400 is illustratively configured so that portions 402 provide the rear running lights of vehicle 100 that are illuminated by light sources 114a, 114e; portions 404 provide the brake lights of vehicle 100 that are illuminated by light sources 114b, 114d; and portion 406 provides the center high mounted stop light of vehicle 100 illuminated by light source 114c. Further the individual light sources 114a-114e can be different colors if different portions of the light slab, such as light slab 400, are to be illuminated with different colors.

In the example shown in FIGS. 1-3, exterior display surface 110 of light slab 108 is configured as a display 111 of a center high mounted stop light 117 and is appropriately located at a position of a rear of vehicle 100 and body 104 is illustratively a trim strip. Exterior display surface 110 of light slab 108 in cooperation with light source 114 and optical waveguide 116 comprises center high mounted stop light 117.

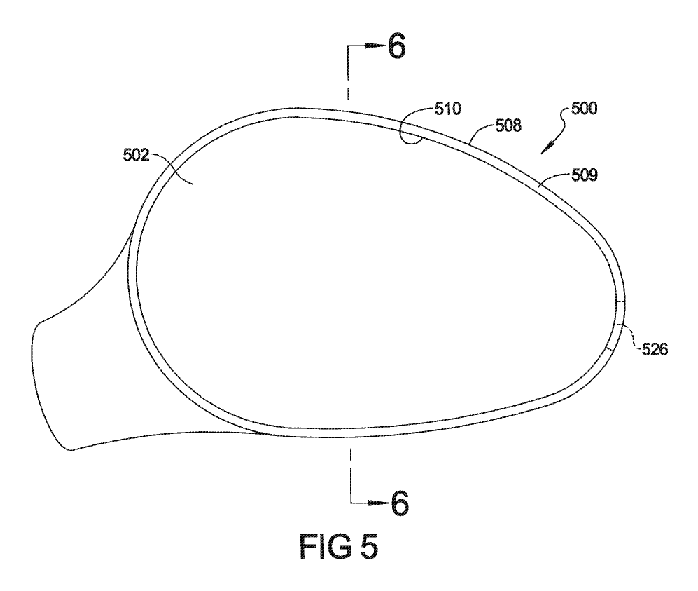

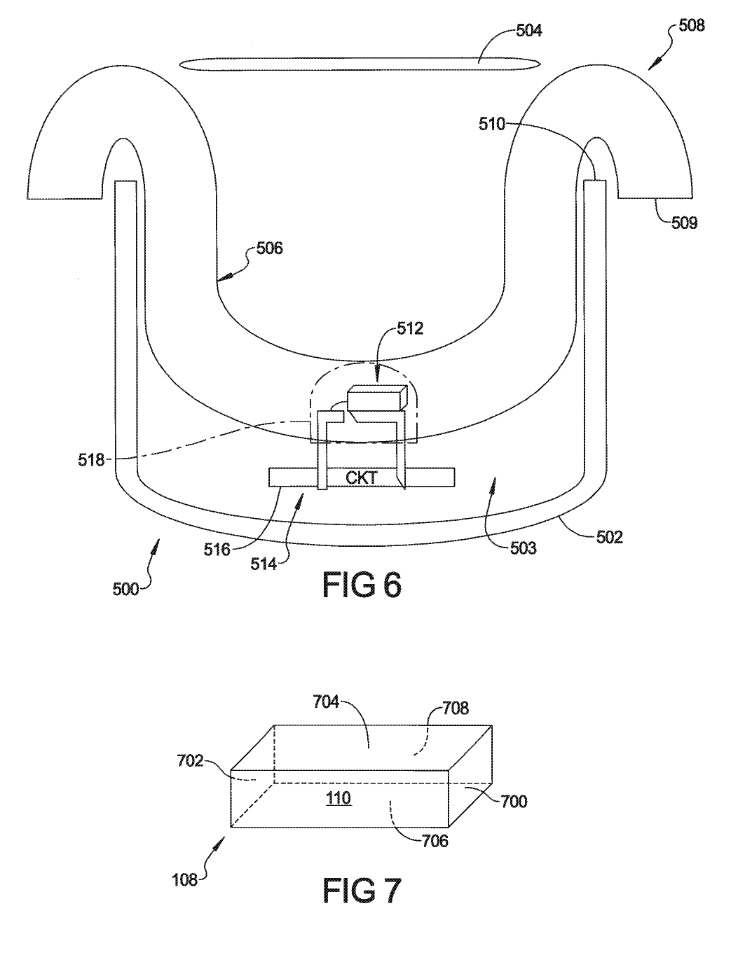

With reference to FIGS. 5 and 6, in accordance with an aspect of the present disclosure, an exterior mirror assembly 500 for an automotive vehicle such as automotive vehicle 100 has a mirror case 502 surrounding a mirror 504 (FIG. 6) and a mirror adjustment mechanism (not shown). Mirror assembly 500 has an optical waveguide 506 (FIG. 6) having a distal end portion 508 that provides an exterior display surface 509 that is contiguous with at least a portion of a periphery 510 of mirror case 502. In an aspect, distal end portion 508 of optical waveguide 506 extends around periphery 510 of mirror case 502 and exterior display surface 509 is thus contiguous with periphery 510 around periphery 510. In this regard, distal end portion 508 serves a light slab having an exterior display surface where optical waveguide 506 integrally includes the light slab as distal end portion 508. Optical waveguide 506 is coupled to a hidden light source 512 located remote from the periphery 510 of mirror case 502. Illustratively, light source 512 is included in a light engine 514 that is located in an interior 503 of mirror case 502. Light engine 514 also includes a light source circuit 516 that drives light source 512. In an example, light source 512 is a light emitting diode and light source circuit 516 includes a light emitting diode drive circuit. In an example, light source circuit 516 is controlled by an electronic control unit of vehicle 100 that for example, controls light source circuit 516 to activate light source 512 on, such as to flash light source 512, when a driver activates a turn signal. Optical waveguide 506, with the exception of exterior display surface 509, is a hidden optical waveguide in that it is masked from view from an exterior of mirror assembly 500. In the example of FIGS. 5 and 6, optical waveguide 506 with the exception of exterior display surface 509 is disposed in interior 503 of mirror case 502 and is masked from view by mirror case 502 and mirror 504.

In an aspect, optical waveguide 506 includes an optically engineered lens 518 (shown in phantom in FIG. 5) that flutes the light from light source 512 into optical waveguide 506. In an aspect, lens 518 is a separate component and in another aspect, lens 518 is formed during the formation of optical waveguide 506, such as by co-molding lens 518 and optical waveguide 506.

It should be understood that in an aspect light source 512 includes a plurality of light sources 512 that are separately controlled by light source circuit 516, such as to have a flashing pattern around exterior display surface 509 of optical waveguide 506. In an aspect, the lights sources 512 are controlled by light source 516 to have variable intensities.

Since distal end portion 508 of optical waveguide 506 is clear with exterior display surface 509 thus also being clear and is part of exterior mirror assembly 500 being disposed around the periphery 510 of mirror case 502, when optical waveguide 506 is not lit, the exterior display surface 509 of distal end portion 508 of optical waveguide has the same color to a casual observer as the color of mirror case 502. An exterior 520 of mirror case 502 and exterior display surface 509 of distal end portion 508 of optical waveguide 506 comprise a Class A surface 522. It should be understood that exterior display surface 509 is contiguous with exterior 520 of mirror case 502 around the periphery 510 of mirror case 502. Thus, when optical waveguide 506 is unlit, the Class A surface 522 that is the exterior 520 of mirror case 502, and in particular around periphery 510 of mirror case 502, and the exterior display surface 509 of optical waveguide 506 will be a uniform Class A surface. This in effect obscures exterior display surface 509 of distal end portion 508 of optical waveguide 506 from appearing as a separate, distinct component from mirror case 502. In contrast, when light source 512 is on, exterior display surface 509 of distal end portion 508 of optical waveguide 506 is illuminated by light from light source 512 being directed by optical waveguide 506 to exterior display surface 509 that radiates a visible light to an observer. Further, by remoting light source 512 from the periphery 510 of mirror case 502, there is more flexibility in packaging of light source 512 and optical waveguide 506, and in styling and design of exterior display surface 509 of distal end portion 508 of optical waveguide 506. Also, by having light source 512 located remote from exterior display surface 509, this allows light engine 514 that includes light source 512 to be located remote from the periphery 510 of mirror case 502 protecting the parts of light engine 514 such as electronics from the outside environment. In an aspect, light engine 514 is located in the interior of vehicle 100 instead of in the interior of mirror case 502.

In a further aspect and with reference to FIG. 3, assembly 102 includes an optical sensor 304 that is illustratively part of light engine 300. In an aspect, optical sensor 304 is a light sensor and in an aspect, optical sensor 304 is a camera, such as a charge coupled device camera sensor. Circuit 302 is then also a circuit responsive to optical sensor 304. Optical sensor 304 is responsive to light entering light entering light slab 108 from the exterior of vehicle 100 through exterior display surface 110, illustratively from a sensor section 306 (shown in phantom in FIG. 3) of exterior display surface 110. In this aspect, optical sensor 304 responds to sensor section 306 being blocked and provides an input to vehicle 100 indicative to sensor section 306 being blocked. For example, vehicle 100 may respond to sensor section 306 being blocked such as by a user blocking it with a hand and open or close a liftgate of vehicle 100 or unlock doors of vehicle 100. It should be understood that vehicle 100 may respond in other ways to sensor section 306 being blocked.

In a further aspect and with reference to FIGS. 5 and 6, mirror assembly 500 includes an optical sensor 524 that is illustratively part of light engine 514. In an aspect, optical sensor 524 is a light sensor and an aspect, optical sensor 524 is a camera, such as a charge coupled device camera sensor. Circuit 516 is then also a circuit responsive to optical sensor 524. Optical sensor 524 is responsive to light entering light entering optical waveguide 506 from the exterior of mirror 500 through exterior display surface 509, illustratively from a sensor section 526 (FIG. 6) of exterior display surface 509 being blocked. In this aspect, optical sensor 524 responds to sensor section 526 being blocked and provides an input to vehicle 100 indicative of sensor section 526 being blocked. For example, vehicle 100 may respond to sensor section 526 being blocked such as by a user blocking it with a hand and unlock doors of vehicle 100. It should be understood that vehicle 100 may respond in other ways to sensor section 526 being blocked.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An assembly for an automotive vehicle, comprising:
a body having an opaque Class A exterior surface;
a light slab having a clear exterior display surface contiguous to the opaque Class A surface;
a hidden light source disposed remote from the clear exterior display surface of the light slab and coupled to the light slab by a hidden optical waveguide; and
the exterior Class A surface of the body and the display surface of the light slab cooperating to provide a uniform Class A surface when the light slab is unlit.

2. The assembly of claim 1 wherein an interior surface of the light slab that is opposite the exterior display surface presents a masking color.

3. The assembly of claim 2 wherein the optical waveguide includes an optically engineered lens that flutes light from the light source to the light slab through the optical waveguide.

4. The assembly of claim 3 wherein the light slab is a distal end of the optical waveguide.

5. The assembly of claim 2 wherein the light slab is integral with the body.

6. The assembly of claim 2 wherein the light slab and the body are separate parts.

7. The assembly of claim 2 wherein the external display surface of the light slab is configured as a display of a center high mounted stop light.

8. The assembly of claim 2 wherein the optical waveguide is disposed behind the Class A exterior surface of the body and masked from view from an exterior of the vehicle by the Class A exterior surface of the body.

9. The assembly of claim 2 wherein the external display surface of a light slab is configured to have a plurality of portion with portions providing rear running lights of the vehicle, portions providing brake lights of the vehicle and a portion providing a center high mounted stop light and the light source is configured to have a plurality of light sources corresponding to the plurality of portions of the external display surface.

10. The assembly of claim 1 and further including an optical sensor responsive to a sensor section of the exterior display surface being blocked and providing an input indicative thereof to the vehicle.

11. The assembly of claim 1 wherein the assembly is an exterior mirror for the vehicle with the body a mirror case of the mirror and the exterior display surface of the light slab is contiguous with at least a portion of a periphery of the mirror case.

12. The assembly of claim 11 wherein the optical waveguide the light slab is a distal end portion of the optical waveguide.

13. The assembly of claim 12 wherein the exterior display surface extends around the periphery of the mirror case.

14. The assembly of claim 11 wherein the optical waveguide includes an optically engineered lens that flutes light from the light source to the light slab through the optical waveguide.

15. The assembly of claim 11 and further including an optical sensor responsive to a sensor section of the exterior display surface being blocked and providing an input indicative thereof to the vehicle.
